(19) United States
(12) Patent Application Publication
(10) Pub. No.: US 2022/0379679 A1
(43) Pub. Date: Dec. 1, 2022

(54) VEHICLE SYSTEM CONTROL BASED ON ROAD FEATURE DETECTION AND CLASSIFICATION

(71) Applicant: ClearMotion, Inc., Billerica, MA (US)

(72) Inventors: John Parker Eisenmann, Burlington, MA (US); William Graves, Somerville, MA (US); Allen Chung-Hao Chen, San Jose, CA (US); Marco Giovanardi, Melrose, MA (US)

(73) Assignee: ClearMotion, Inc., Billerica, MA (US)

(21) Appl. No.: 17/772,036

(22) PCT Filed: Nov. 3, 2020
(86) PCT No.: PCT/US2020/058723

§ 371 Date: Apr. 26, 2022

Related U.S. Application Data
(60) Provisional application No. 62/930,295, filed on Nov. 4, 2019.

(51) Int. Cl. B60G 17/0165; B60G 17/019

(52) U.S. Cl. CPC B60G 17/0165; B60G 17/01908; B60G 2400/10

(57) ABSTRACT

In some embodiments, methods and systems may be used to control operation of various systems of the vehicle based on road features included in an upcoming portion of a road surface located along a path of travel of the vehicle. This control may either be based on a probability of encountering a road feature on the road surface 5 and/or frequency information related to the upcoming portion of the road surface.

### CROSS-REFERENCE TO RELATED APPLICATIONS

This application claims the benefit under 35 U.S.C. § 119(e) of U.S. provisional application Ser. No. 62/930,295, filed Nov. 4, 2019, the disclosures of which are incorporated by reference in their entirety.

### FIELD

Disclosed embodiments are related to vehicle system control based on road feature detection and classification.

### BACKGROUND

Road vehicles may contain many automatic, semi-automatic, or manually operated systems that may change their functionality or state based on an external input. Examples of these include suspension systems with variable damping, e.g. magneto-rheological suspension systems, active roll stabilizers, anti-lock braking systems, stability control systems, propulsion systems active seats, variable seats, but also systems like temperature control, safety settings, and radio volume, or systems like air bag setpoints or power steering feedback.

### SUMMARY

In one embodiment, a method of controlling one or more systems includes: identifying a portion of a road surface along a path of travel of a vehicle; obtaining reference spatial frequency data related to the portion of the road surface along the path of travel of the vehicle; determining a velocity of the vehicle; transforming the reference spatial frequency data into temporal frequency data using the determined velocity of the vehicle; and controlling the one or more systems based at least in part on the temporal frequency data.

In one embodiment, a method of controlling one or more systems includes: identifying a road feature disposed along a path of travel of a vehicle; obtaining a probability of encountering the road feature as a function of a velocity of the vehicle; determining a velocity of the vehicle; determining the probability of encountering the road feature based on the velocity of the vehicle; and controlling one or more systems based at least in part on the determined probability of encountering the road feature.

In one embodiment, a vehicle may include one or more systems, a localization system configured to determine a location of the vehicle, and a processor. The processor may be configured to: identify a portion of a road surface along a path of travel of a vehicle based on an input from the localization system; obtain reference spatial frequency data related to the portion of the road surface along the path of travel of the vehicle; determine a velocity of the vehicle; transform the reference spatial frequency data into temporal frequency data using the determined velocity of the vehicle; and control the one or more systems based at least in part on the temporal frequency data.

In one embodiment, a vehicle may include one or more systems, a localization system configured to determine a location of the vehicle, and a processor. The processor may be configured to: identify a road feature disposed along a path of travel of the vehicle; obtain a probability of encountering the road feature as a function of a velocity of the vehicle; determine a velocity of the vehicle; determine the probability of encountering the road feature based on the velocity of the vehicle; and control the one or more systems based at least in part on the determined probability of encountering the road feature.

In one embodiment, a method of generating a road map for use in controlling a vehicle system includes: determining if each vehicle of a plurality of vehicles that traverse a road surface encounter a road feature; determining a velocity of each vehicle; determining a probability of encountering the road feature as a function of the velocity; and storing a model related to the probability of encountering the road feature in a non-transitory processor readable memory for future recall and/or use.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic representation of one embodiment of a vehicle;

FIG. 2 is a schematic representation of one embodiment of a processor configured to control one or more systems of a vehicle;

FIG. 3A is a graph of exemplary road height data versus distance;

FIG. 3B is a graph of the data of FIG. 3A transformed into the spatial frequency domain;

FIG. 3C is a graph of the data of FIG. 3B including a fitted curve based on a subset of the data;

FIG. 3D is a graph of the data of FIG. 3C transformed into the temporal frequency domain and binned into a plurality of bins corresponding to separate frequency bands;

FIG. 4 is a schematic representation of one embodiment of a vehicle traversing a road surface including road inputs, such as height variations, that have a spatial frequency approximately equal to a length between the wheels of the vehicle in the longitudinal direction of the vehicle;

FIG. 5 is a flow diagram of one embodiment of a method for providing reference spatial frequency data for a road surface;

FIG. 6 is a flow diagram of one embodiment of a method for controlling a vehicle system using temporal frequency data;

FIG. 7 is a flow diagram of one embodiment of a method for determining the probability of encountering a road feature as a function of vehicle velocity;

FIG. 8 is a flow diagram of one embodiment of a method for controlling a vehicle system based on a probability of encountering a road feature as a function of vehicle velocity; and

FIG. 9 is an exemplary graph of the probability of encountering a road feature versus vehicle velocity.

### DETAILED DESCRIPTION

Vehicles may travel over wide geographic areas which may include a number of different roads or road segments each of which may exhibit different types and/or severities of road features that may be encountered by a vehicle traversing the road. Additionally, the road surfaces of these roads may change over time and/or due to weather conditions, which may further complicate event prediction and operation of systems of a vehicle traversing such roads. Road features also may not be present across the entire road surface. For example, a pothole may be present on one side of a travel lane, but a vehicle may, intentionally or unintentionally, avoid the pothole, or other feature, when traveling in a different portion of that travel lane. Geographic positioning techniques have also tended to either not exhibit sufficient accuracy and/or are too computationally complex to permit the usage of vehicle location data to be meaningfully used to control or modify the operation of various automatic, semi-automatic and/or manually operated systems of a vehicle.

In view of the above difficulties, typical vehicle systems have used information about a road surface that is sensed in real time by one or more sensors located on a vehicle to determine what road features are either upcoming, and/or that have already occurred. However, sensing, processing, and using information related to an upcoming road feature, or a road feature that a vehicle has already passed (e.g. a pothole sensed by an accelerometer positioned on a vehicle) may create a latency or lag in responding to changes in the road, and specifically in responding to rapid events. For example, with such systems a pothole may be recognized as a pothole after a vehicle has traversed at least a portion of it, and even then only a statistical guess may be made about the location and height of an upcoming trailing edge of the pothole. Such a delay in processing real time measurements and the inherent uncertainty associated with sensor inputs that may not provide sufficient timely information about an event and may lead to poor system performance for a given event. Accordingly, vehicles tend to use “conservative” settings in their control algorithms to ensure a minimum acceptable vehicle performance. However, such an operating method may not fully utilize the capabilities of various systems of a vehicle.

In view of the above difficulties in using real time measurements to control operation of the various systems of a vehicle, the inventors have recognized that it may be desirable to control one or more operations of one or more systems of a vehicle using historical and/or statistical data related to a localized position and a path of travel of a vehicle. Thus, one or more operating parameters of one or more systems of the vehicle may be controlled using operating parameters that are determined at least partly based on the historical and/or statistical data of a road surface about to be traversed. For example, as elaborated on below, in some embodiments, a system may preview the upcoming portion of a road to determine the types of road features that may be encountered on that portion of a road surface. Such information may then be used, for example, to set one or more operating parameters of a system. For instance, some systems may have preferred setpoints or behaviors that may be determined based at least in part on the types of road features that may be encountered when traversing a road surface. When controlled in this manner, the systems may provide improved performance relative to systems controlled using conservative operating parameters or settings that are determined without timely consideration for the specific road surface being traversed.

In one embodiment, one or more vehicle systems may be controlled by identifying a portion of the road surface that corresponds to a path of travel that the vehicle is traversing. The identified portion of the road may then be used to obtain reference spatial frequency data related to the portion of the road located along an upcoming portion of the vehicle's path of travel. This reference spatial frequency data may have been previously obtained as detailed further below. However, to facilitate usage of the reference spatial frequency data, it may be useful to transform the data from the spatial frequency domain to the temporal frequency domain. Specifically, a velocity of the vehicle may be determined and the reference spatial frequency data may be transformed into temporal frequency data using the determined velocity of the vehicle. Depending on the desired application, the temporal frequency data may be used to control one or more operating parameters of the one or more vehicle systems. Exemplary methods of controlling systems based on the temporal frequency data are elaborated on below.

Additionally or alternatively, in another embodiment, one or more vehicle systems may be controlled based on a probability of whether or not a particular road feature may be encountered by a vehicle. Specifically, a portion of a road surface that corresponds to a path of travel of a vehicle traversing the road surface may be identified. Additionally, a road feature that is present on the identified portion of the road surface may also be identified. A previously determined probability of encountering the road feature may be at least partially dependent on, for example, a velocity of the vehicle, a width of the feature, a width of the travel lane, a visibility of the feature by operators, and other factors. For example, if a vehicle is traveling sufficiently fast, a road feature, such as a pothole, may not be observed above a threshold velocity due to the wheel skipping over the pothole as compared to traversing the same pothole at a slower velocity where the wheel sinks into the hole and impacts against a trailing edge of the pothole. Accordingly, a velocity of the vehicle may be determined and a probability of the vehicle encountering the road feature may be determined using the velocity. One or more operating parameters of the one or more vehicle systems may then be controlled based at least partly on the determined probability of encountering the road feature.

In the above embodiment, the one or more operating parameters of the one or more vehicle systems may be controlled in an appropriate manner relative to the determined probability of encountering the road feature. For example, an operating parameter of a system may be proportional to the determined probability (increasing control parameters such as damping coefficients); may be toggled between different operating modes based on comparison to one or more threshold probabilities (on/off, different levels of actuation ranging from 0% actuation to 100% actuation, etc.), and/or any other appropriate method of controlling an operating parameter of a system relative to the determined probability may be used as the disclosure is not so limited.

In some embodiments, to facilitate controlling the operation of one or more vehicle systems, it may be desirable to determine the probability of encountering a road feature on a particular portion of a road surface. While this may be done in any number of ways, in some embodiments, information related to a plurality of previous instances in which a vehicle has traversed a particular road surface may be obtained. This may correspond either to information from a single vehicle traversing the same road surface and/or multiple vehicles traversing the same road surface. In either case, information, such as for example, a velocity of each vehicle when traversing a particular portion of the road surface may be determined for each recorded instance. One or more sensor signals recorded during traversal of the portion of the road surface may be indicative of whether the vehicle encountered a road feature on that particular portion of the road as detailed further below. In instances where the recorded signals indicate that the road feature has been encountered, such as a signal above a threshold value or other appropriate metric, that particular traversal may be considered to be a “hit”. In contrast, if the recorded signals indicate that the road feature was not encountered, that particular traversal may be considered to be a “miss”. By aggregating the information from the different traversals of the road surface, it is possible to determine a probability of encountering the road feature as a function of a velocity of a vehicle. This may either be determined using a fitted function, a lookup table, and/or any other appropriate method. In either case, this may enable the use of a statistical model associated with a road surface to be used to control operation of the one or more systems of the vehicle based on predicted and/or previously recorded information associated with road surface which may again improve operation of the vehicle relative to typical control strategies.

In view of the above, in some embodiments, systems in a road vehicle may use algorithms that modify the operation of one or more of those systems based on external factors such as velocity, driver input, and the types and severity of road features located on a road surface of a road that the vehicle is being driven across. Some systems may also have automatic or adaptive settings, where the system may attempt to control performance of the system based on the road being traversed. For example, the desired operation of a system when traversing a highway bridge may be very different from the desired operation of the system when driving along an unpaved dirt road. Thus, the ability to use a priori knowledge about sections of road of a pre-determined length that the vehicle is about to traverse may allow operation of these vehicle systems to be more appropriately controlled for the actual conditions that are expected to be encountered by the vehicle based on previously measured data and/or statistical models of the road surface to be traversed before the vehicle encounters that section of road.

A road feature may correspond to any detectable feature on a road surface that results in a force or motion input to a portion of the vehicle as the vehicle traverses the road surface within a relevant frequency range for operation of a desired system. For example, road features may correspond to elevation changes in a road surface that may result in force inputs to various portions of a vehicle such as the wheels, vehicle body, passenger cabin, passenger seats, and/or other appropriate portions of the vehicle, or may correspond to road content that imparts a yaw moment or a lateral force on the vehicle, or may correspond to road inputs that are potentially damaging to vehicle components.

In the temporal domain, a temporal frequency of the input to the vehicle from relevant road features may be greater than or equal to 0.01 Hz, 0.1 Hz, 1 Hz, 2 Hz, 3 Hz, 4 Hz, 5 Hz, 10 Hz. and/or any other appropriate frequency range. Correspondingly, the temporal frequency range of an input from a road feature may be less than or equal to 30 Hz, 20 Hz, 10 Hz, 5 Hz, 4 Hz, 3 Hz, 2 Hz, 1 Hz, and/or any other appropriate range. Combinations of the foregoing ranges are contemplated including, a temporal frequency range of an input to a vehicle by a road feature that is between or equal to 0.01 Hz and 30 Hz. Of course, ranges both greater than and less than those noted above are also contemplated as the disclosure is not so limited.

In the spatial domain, a frequency of an input to a vehicle from a relevant road feature may vary from inputs from gently rolling hills to inputs from pebbles located on a dirt road and include, for example, potholes, manhole covers, cracks in the road surface, expansion joints, storm drain covers etc. Accordingly, a spatial wavelength, defined as the inverse of spatial frequency, for a road feature may be greater than or equal to 0.01 m, 0.1 m, 1 m, 10 m, 100 m, and/or any other appropriate spatial wavelength. Correspondingly, the spatial frequency of a road feature may be less than or equal to 1000 m, 100 m, 10 m, 1 m, 0.1 m, and/or any other appropriate spatial wavelength. Combinations of the foregoing including, for example, a spatial frequency of road features may be between or equal to 0.01 m and 1000 m, 0.1 m and 1 m and/or any other appropriate combination. Of course, ranges both greater than and less than those noted above are also contemplated as the disclosure is not so limited. Additionally, it should be understood that the various ranges of temporal and spatial frequencies may be related to one another using a velocity of a vehicle as it traverses the noted road features.

It should be understood that the current disclosure is not limited to any particular type of road feature. However, appropriate types of road features that may be considered using any of the methods and systems disclosed herein may include, but are not limited to, potholes, manhole covers, storm grates, expansion joints, frost heave, a crest of a hill, overall surface roughness of a road surface, cracks in the road surface, storm grates etc. freeway hop joints, road swells, banked turns, loose gravel, pavement shoving sections, and/or any other appropriate detectable feature on a road surface that results in a relevant input to a portion of a vehicle while traversing a road surface. Thus, the current disclosure is not limited to only the specific examples of road features described herein.

The systems and methods described herein may obtain information related to an upcoming portion of a road surface using information associated with a roadmap. The roadmap may include information related to both a location and direction(s) of travel across a road surface in addition to information such as height variations, sensed accelerations applied to a vehicle while traversing the road surface, information regarding road features, and/or any other appropriate parameter that may be associated with a road surface. For example, height variations along one or more lanes of travel on a road surface may be included in a roadmap. Additionally, depending on the embodiment, the information may be transformed into one or more different parameters including, for example, a spatial frequency spectrum that may be included in a road map for an upcoming portion of a road surface. However, regardless of the specific information included in a roadmap, the roadmap may be provided to a vehicle in a number of ways. For example, in one embodiment, the roadmap may be stored on non-transitory processor readable memory included on board a vehicle. Alternatively, a roadmap may be uploaded to a buffer on the vehicle from a remote database using any appropriate wireless communication method. Thus, a relevant portion of a roadmap surrounding a location of a vehicle, and/or along a path of travel of a vehicle, may be included in the buffer for use by one or more processors of the vehicle. As the vehicle traverses the road surface, the portion of the roadmap uploaded to the buffer may be correspondingly updated to ensure that a desired portion of a road surface along the path of travel of the vehicle is included in the buffer. Thus, it should be understood that the types of information included in a roadmap and/or the manner in which a roadmap is provided to a vehicle is not limited to any specific implementation.

The information included in a roadmap may also be provided in any appropriate fashion. For example, in some embodiments, road features may be identified along a road surface being mapped using real-time detection based on vehicle sensors. These sensors may include, but are not limited to, accelerometers and position sensors on the vehicle, in order to record inputs from the road surface. In some embodiments, other sensors such as Lidar, Radar, optical based sensors, and/or any other appropriate sensor capable of measuring an input from the road surface to a portion of the vehicle and/or a location of the vehicle relative to a road surface may be used to identify road features on a road surface. Additionally, localization systems capable of determining a location of a vehicle on a road surface when sensing the inputs from the road surface to the vehicle may be used. For example, a global navigation satellite system (GNSS), terrain based localization systems, real-time kinematic data, localization based off recognizable features such as road signs, and/or any other appropriate localization system may be used to determine an absolute location of a vehicle on a road surface associated with the detected information. In some embodiments, the recorded information may come from a single vehicle, or other source, or the recorded information may be based on crowd-sourced roadmap where information related to a particular road surface is recorded by a plurality of vehicles traversing that road surface and aggregated to generate an aggregated roadmap. However, the current disclosure is not limited to the use of roadmaps generated in such a manner. Alternatively, in some embodiments, the road features and related information included in a road map may be obtained from other information sources including known or static road profiles. For instance, a roadmap may be generated by any other appropriate method including, but not limited to, laser road scanning, camera-based road mapping, ground-penetrating radar (which may be used to detect sub-surface features) and others.

When looking at a relevant portion of a road surface that is located along a path of travel of a vehicle, it may be desirable to limit a length of the road surface that is being analyzed for controlling operation of one or more systems of a vehicle. The selected portion of the road surface may be continually updated, periodically updated, and/or updated in any other appropriate fashion as the vehicle travels along the road surface. In either case, a length of a portion of a road surface that is analyzed may be greater than or equal to 10 m, 20 m, 50 m, 100 m, 500 m, and/or any other appropriate distance. Correspondingly, the portion of the road surface that is located along an upcoming path of travel of the vehicle may have a length that is less than or equal to 2000 m, 1000 m, 500 m, 100 m, 50 m, 20 meters and/or any other appropriate distance. Combinations of the foregoing ranges are contemplated including, for example, a portion of the road surface located along a path of travel of the vehicle that is being analyzed may be between or equal to 10 m and 2000 m. Of course, lengths both greater than and less than those noted above are contemplated as the disclosure is not limited in this fashion. Additionally, the selected length may either be a preset length that does not change and/or the length may vary based on application, user settings, or other appropriate input as the disclosure is not limited to how a predetermined length of a road surface to be analyzed is selected.

The various methods described herein may be used with any appropriate system included on a vehicle traversing a road surface. For example, vehicle systems may include systems such as an active roll bar, which has the ability to induce roll moments on the front and/or rear axle, allow a vehicle to traverse a high level of roll undulations (also called road camber, in that the road contains a lot of slope in the direction associated with camber angle in the suspension) without forcing the vehicle to follow them, thus allowing for a smooth ride, while still maintaining good road contact and a high degree of roll stiffness for handling inputs. If the content of the road ahead is known a priori, it may be examined for road camber and for the size of the largest single wheel bump, for example, allowing the controller settings for the active roll system to be tuned to isolate the vehicle from the inputs from these road features to a greater degree without losing road contact (or running out of travel on the suspension). For instance, parameters of an active roll bar that may be varied may include, but are not limited to, controller settings governing the effective stiffness of the bar, the effective damping, or the amount of roll moment created by the bar at any given time. In general, a desired setpoint or tuning of such a system may be at least in part dependent on the road features present on a portion of the upcoming road surface. This may allow the vehicle roll bar to track better on smooth roads but better isolate the vehicle from inputs from a road surface on rough secondary roads or off-road. Thus, with advanced knowledge of the road features included on a road surface a long distance ahead of the vehicle, the system may set one or more operating parameters of the device in advance such that they are more suited for the upcoming portion of a road as compared to maintaining a more conservative controls to maintain a minimum acceptable performance of the device. Preview information about upcoming road content may also be learned from camera or lidar sensors on the vehicle, but this information is typically both situationally limited to situations of good visibility and no occlusions by leaves, snow or other objects, and spatially limited to a short distance ahead of the vehicle. Therefore, such systems may have inferior performance under many operating conditions. This may again lead to improved performance of the vehicle and/or greater comfort of a vehicle occupant.

Another example of a vehicle system is that of an active or semi-active suspension. These types of systems may have the ability to rapidly change damping levels, and thus, affect a reactive force applied by the damper to a vehicle, and/or actively apply a force in the case of an active suspension, that is appropriately tuned to react on a timescale of the force inputs applied to a vehicle body by the road features encountered while traversing the road surface. The system may change the thresholds for the controller to, for example, react more aggressively to road events on a smooth road (in order to avoid “floatiness”) and less aggressively to events on a rough road (in order to avoid “chop”). This change in controller tuning may also be based on other characteristics of the road and road surface, such as for example its grip or its roughness. For instance, in the case of semi-active suspensions, the damping characteristics in one or more desired frequency ranges can be affected by actively controlling the valves, flow restrictions, or other hydraulic control systems included in the semi-active suspension to change the damping characteristics of the system in the desired fashion. Similarly, a hydraulic device such as a pump, valve, flow restriction, an electric device such as a motor or electromagnet, or other system may be actively controlled to vary the frequency characteristics and/or magnitudes of the active and/or damping forces output from an active suspension system. In either case, the various types of suspension systems may be operated based on the information related to the upcoming portion of a road surface to either better isolate a vehicle from inputs from a road surface and/or to maintain contact with the ground depending on the type and severity of the road features included along the road surface as detailed further below.

In view of the above, road preview where information related to an upcoming portion of a road surface is used to control one or more aspects of the operation of a system of a vehicle may enhance the performance of vehicle systems by allowing them to choose the operating parameters for algorithms that may vary based on the road features included in the upcoming portion of the road surface. While the descriptions herein are focused on suspension systems of a vehicle, it should be understood that these methods and systems may be applied to many other vehicle systems that have variable settings, such as vehicle stability systems and crash prevention, as well as other systems that are influenced by the type of road a vehicle is traversing. For any of these systems, it is beneficial to reliably know the upcoming road features present on a road surface, and to not be limited due to environmental factors such as low visibility, objects on the road, or by actuation delays in the event that the upcoming road surface is not known sufficiently long ahead of the vehicle, for example at least 1 second or more in advance. Examples of such systems may include, but are not limited to: button settings and push sensitivity that might adapt to how rough a road is in order to prevent accidental activation; cabin settings that might adapt to road conditions; electronic steering system settings; active engine mounts; active rear steer; air suspensions; active damping systems; active roll suspensions; seating systems such as active seats and air ride seats; and cabin isolation systems such as cabin air ride; and/or any other appropriate active and/or semi-active system included on a vehicle that may benefit from changing operation based on the conditions encountered when traversing different road surfaces. These methods and systems may be applied to any appropriate type of road vehicle, large or small, but may also be applied to rail vehicles or other vehicles running on tracks, such as autonomous transport vehicles or shuttles where the road surface may be considered to be the surfaces of the rails or other appropriate surface that a vehicle is traversing during operation.

As used herein, heave may refer to a vertical motion of a vehicle relative to an underlying surface that a vehicle is supported on. Correspondingly, the vehicle may have a longitudinal axis extending along a length of the vehicle and parallel to the supporting surface, for example the road, and a transverse axis that is perpendicular to the longitudinal axis and parallel to the supporting surface when the vehicle is disposed on a flat level surface. Thus, roll of the vehicle may correspond to rotation of the vehicle about a longitudinal axis, yaw may refer to rotation of the vehicle about a vertical axis that is perpendicular to both the longitudinal and transverse axes and consequently the supporting surface, and pitch may refer to rotation of the vehicle about a transverse axis.

The various embodiments of methods and vehicles described herein may be used to control any number of different systems on a vehicle as the disclosure is not limited to which systems of a vehicle are controlled. For example, vehicle systems that may be at least partially controlled based on information related to road features present on a road surface may include automatic, semi-automatic and/or manually operated systems that may include one or more operating parameters, settings, and/or control algorithms that may be at least partially controlled using information related to the road surface. Non-limiting examples of systems that may be controlled may include, but are not limited to active and semi-active suspension systems, steering systems, braking systems, and safety systems as well as interior systems relating to lighting, audio systems, window motor operation, and any other appropriate vehicle system as the disclosure is not limited in this fashion.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

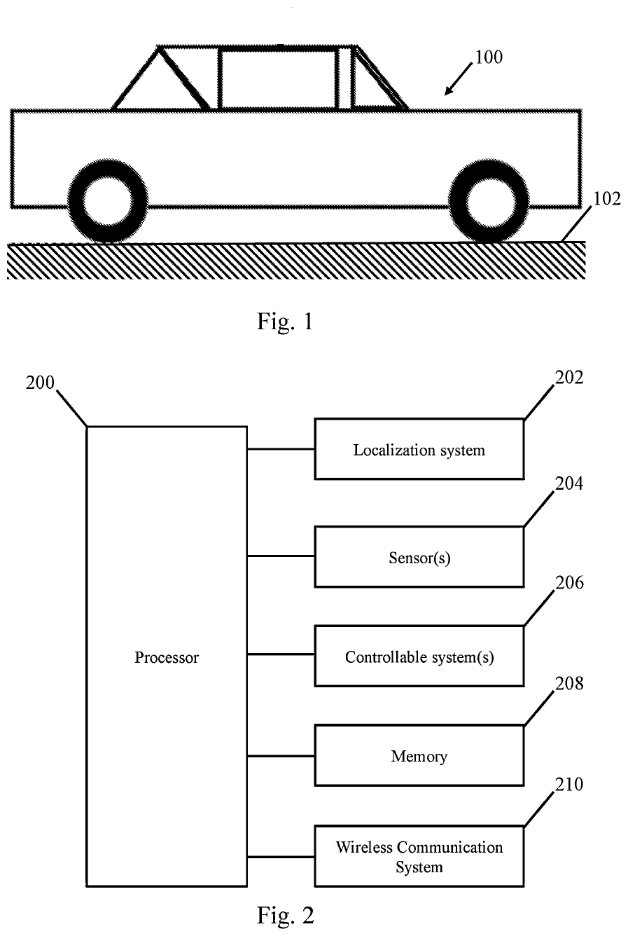

FIG. 1 depicts a vehicle 100 traversing a road surface 102 which may include one or more road features along its length. In some embodiments, the vehicle may include various sensors and control systems as depicted in FIG. 2. In the depicted figure, a vehicle may include one or more processors, such as the depicted processor 200. The processor may be operatively coupled with a localization system 202, one or more sensors 204, one or more systems 206 that may be controlled, non-transitory processor readable memory 208, and in some embodiments a wireless communication system 210. Appropriate types of localization systems that may be used may include, but are not limited to, GNSS systems, terrain-based localization systems, real-time kinematic global navigation satellite systems, and/or any other appropriate localization system capable of providing a location of a vehicle on a road surface to the processor. Appropriate types of inputs to a processor may include sensor inputs and/or inputs from various systems of a vehicle which may include, but are not limited to, a velocimeter output of a vehicle, a velocity sensor, shaft encoders, steering inputs, braking inputs, accelerometers on the unsprung or sprung mass, wheel speed sensors, displacement sensors measuring the distance between the sprung and unsprung masses, displacement sensors on the steering rack, and/or any other appropriate type of input from a sensor or system included in a vehicle. In embodiments where information, such as a buffered roadmap, is communicated to a vehicle, the wireless communication system may transmit information between the processor and one or more remote databases and/or servers. The memory associated with the one or more processors may include processor executable instructions that when executed cause the processor and the associated systems to perform any of the methods described herein. Depending on the embodiment, a processor may be: a central processor of the vehicle; one or more processors associated with a particular automatic, semi-automatic system, and/or a manually operated system that may be controlled based at least partly information related to an upcoming portion of a road surface; combinations of the foregoing, and/or any other appropriate processor as the disclosure is not limited to a location of where a processor used to execute the disclosed methods is located.

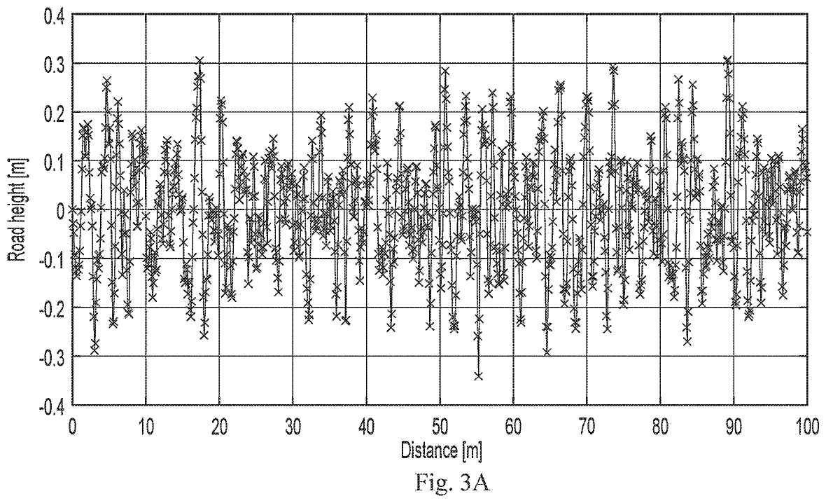

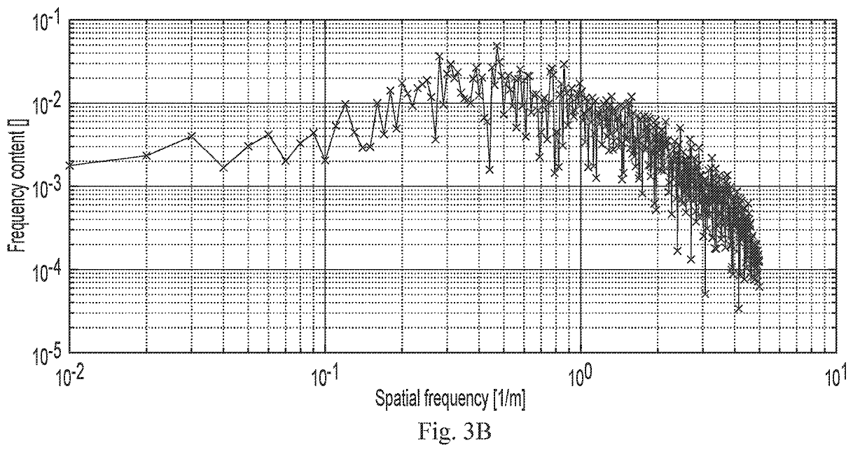

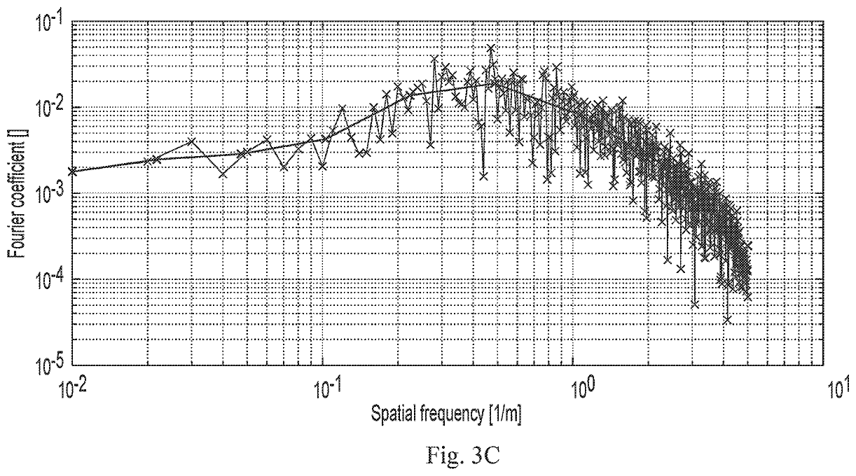

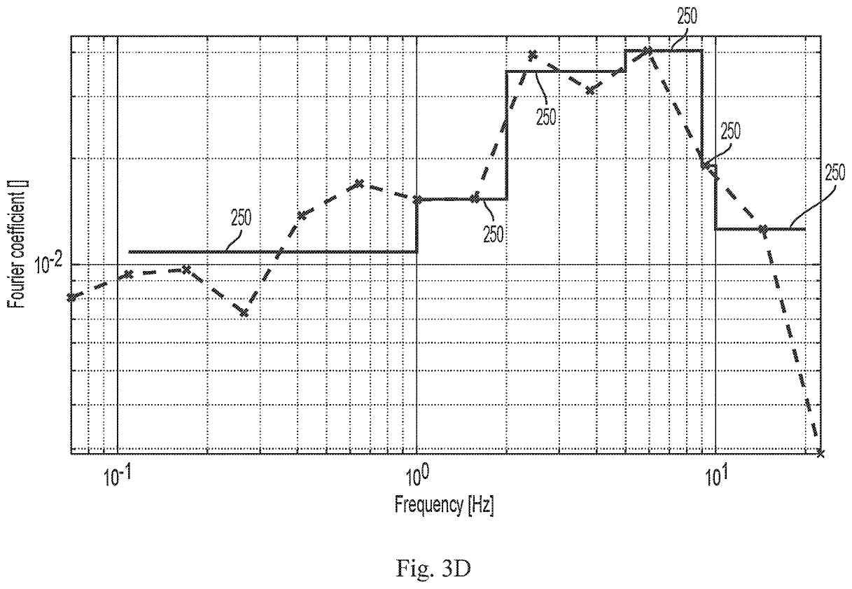

FIGS. 3A-3D depict the information obtained from a road surface and how it might be used to control operation of one or more systems of a vehicle. In some embodiments, road preview may be used to characterize road features included on an upcoming portion of a road surface located along a path of travel of a vehicle. The data related to the road surface may be segmented into segments with a desired length. In the case of a predetermined length, the prerecorded information of the road surface may be segmented into a plurality of segments which may have any desired length. For example, the upcoming road segment shown in FIG. 3A includes a predetermined length of the road surface, which in the figure is 100 m long. In the figure, the road surface height is plotted against the length of the road surface extending along a path of the vehicle. In the depicted figure, the portion of the road surface is subdivided into discrete sub-sections with a fixed number of points which may have a fixed length between them. For example, 100 total points that are equally spaced at 0.1 m intervals are depicted in FIG. 3A. However, different distances, number of points, and/or the use of variable length portions of the road surface and/or sub-sections of the road surface may be used as the disclosure is not limited to only being used with preset length scales.

In some embodiments, the spatial frequency content of a portion of a road surface located in an upcoming road segment may be determined by transforming the data from the spatial domain shown in FIG. 3A to the spatial frequency domain shown in FIG. 3B. While any appropriate method for transforming the data to the spatial frequency domain may be used, in some embodiments, a Fourier transformation such as a fast Fourier transformation (FFT) calculation, discrete Fourier transformation (DFT), single-point discrete Fourier transformations such as using the Goertzel algorithm, Laplace transformation, and/or any other appropriate transformation method may be used. In some embodiments, the FFT may be calculated by windowing the segment with padding, in order to avoid edge effects due to the mathematical process used in the fast Fourier transform (FFT). However, embodiments in which different processing techniques, including techniques in which padding are not used are also possible as the disclosure is not limited to the specific way in which the data is transformed into the spatial frequency domain. Additionally, depending on the specific embodiment, this transformation may be done prior to usage by a vehicle such that the spatial frequency data may be included in a roadmap provided to a vehicle for use in the methods disclosed herein, or it could be done in real time at the time of usage if the road profile data is provided.

While FIG. 3B shows a FFT using all of the data included in FIG. 3B, in some embodiments, a transformation of the data into a spatial frequency domain may be calculated using a number of points that is less than the total number of points included in the initial dataset. For example, if, high resolution is not needed for operation of a particular system, fewer points may be used relative to high resolution systems where additional high accuracy frequency-based information may be advantageous. This may for example be the case for a system operating only in a limited frequency range, for example below 1 Hz, where a differentiation between road content at 2 Hz and 3 Hz would for example not be useful, and the calculation might be done with fewer points. FIG. 3C depicts a transformation of the data included in FIG. 3A into the spatial frequency domain using 10 data points rather than the entire set of data. However, while a particular number of data points has been depicted, it should be understood that the current disclosure is not limited to this particular number of original data points and/or the subset of data points that are used.

Regardless of how the data is transformed into the spatial frequency domain, the spectra depicted in FIGS. 3B and 3C may include information related to the spatial frequencies of road features that are included in an upcoming portion of a road surface. Additionally, the y-axis of the graphs may correspond to an output magnitude from the transformation where larger magnitudes at a particular frequency may be associated with a greater number of road features exhibiting that spatial frequency on the upcoming portion of the road surface. Thus, the depicted spectra may include reference spatial frequency data that is derived from prerecorded information of the road surface, and may be used for controlling one or more operating parameters of a system of a vehicle. Depending on the particular embodiment, these reference spatial frequency data may be determined prior to being provided to a processor of a vehicle for usage, or they may be calculated in the vehicle processor if a road profile including spatial wavelength data is instead provided to the processor. The advance calculation may either be done on a remotely located database or server and/or some amount of this processing may be done on board the vehicle as the disclosure is not limited to where or how the data is processed.

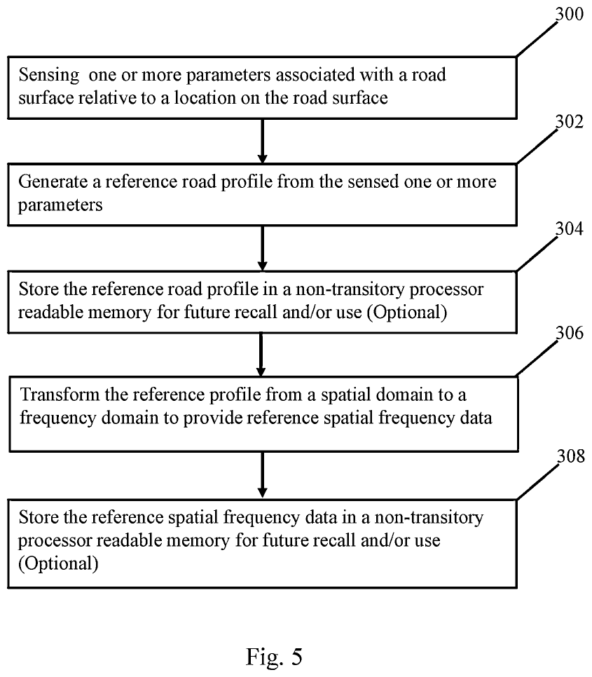

FIG. 5 illustrates one method for implementing a spatial frequency data module for providing the desired reference spatial frequency data. Depending on the embodiment, the spatial frequency data module may be stored and executed at various locations, including by a processor that is associated with a central database and/or server that is remotely located from a vehicle using the resulting roadmaps. For example, a centralized database may be used to aggregate information for compiling roadmaps that may then be distributed to individual vehicles for implementing the methods described herein. However, embodiments in which the probability mapping module is implemented on a processor on board an individual vehicle are also contemplated as the disclosure is not so limited.

In the depicted embodiment, one or more parameters such as height or force inputs to a vehicle relative to an absolute location on a road surface may be sensed at 300. In addition, these one or more parameters, which may be associated with various types of road features located on the road surface, may be localized relative to an absolute position of the sensed road features on the road surface. As noted previously, these road features and absolute position on the road surface may be sensed using any appropriate type of sensor and/or localization system. Thus, the measured or previously known road profile may include data that is referenced to the spatial domain of the road itself. In either case, a reference road profile may be generated from the sensed data which may either correspond to a single mapping process and/or aggregated data provided from multiple vehicles traversing a particular portion of the road and may form a portion of a map at 304. In some embodiments, this road profile may be stored in non-transitory processor readable memory for future recall and/or use. For example, a roadmap including or based on multiple road profiles associated with multiple portions of one or more roads may be stored on the memory. In either case, the reference road profile may be transformed into reference spatial frequency data by transforming the road profile from the spatial domain to the spatial frequency domain using any appropriate technique as noted above at 306. Depending on the application, the reference spatial frequency data may be stored on a non-transitory processor readable memory for future recall and/or use at 308. However, instances in which the data is used without being stored previously are also contemplated.

When a vehicle traverses a given road, the spatial content of the road corresponding to the various road features disposed on the road surface may be encountered by the vehicle at a rate proportional to its forward velocity. The road content as a function of time may be expressed as

$$\frac{\partial z}{\partial t} = \frac{\partial s}{\partial x} * \frac{\partial x}{\partial t} .$$

Similarly, the frequency of the input can be expressed as a function of the spatial frequency as

$$f ( t ) = f ( x ) * \frac{\partial x}{\partial t} .$$

Thus, while the vehicle is travelling along a road, the reference spatial frequency data from FIG. 3B or 3C may be transformed into the temporal domain to provide temporal frequency data associated with the upcoming portion of the road by simply scaling the profile's Fourier transform in both the amplitude and frequency axes using a velocity of the vehicle. Such a transformed spectrum is shown in FIG. 3D.

As described above, temporal frequency data related to an upcoming portion of the road surface for controlling operation of one or more systems may be obtained by scaling reference spatial frequency data related to the portion of the road surface by scaling the abscissa, and in some instances the ordinate, of the spatial frequency data based on the vehicle's velocity. Specifically, multiplying the spatial frequencies of the spectra depicted in FIGS. 3B and 3C, by the velocity, transforms the spatial frequency into a temporal frequency. Additionally, while in some embodiments it may be possible to scale the magnitude of each portion of the data or spectra, since each magnitude would be scaled by the same multiplier, the relative shape and distribution of the magnitudes will not change. However, instances in which a transformation is applied that does not scale the output magnitude of every frequency by the same amount are also contemplated. Regardless of the specific way in which the data is transformed, when transforming the reference spatial frequency data into the temporal domain, the applied vehicle velocity may either be the currently measured vehicle velocity, a predicted vehicle velocity, an averaged vehicle velocity over a predetermined prior time period, and/or any other appropriate measure of the vehicle's velocity as the disclosure is not limited in this fashion.

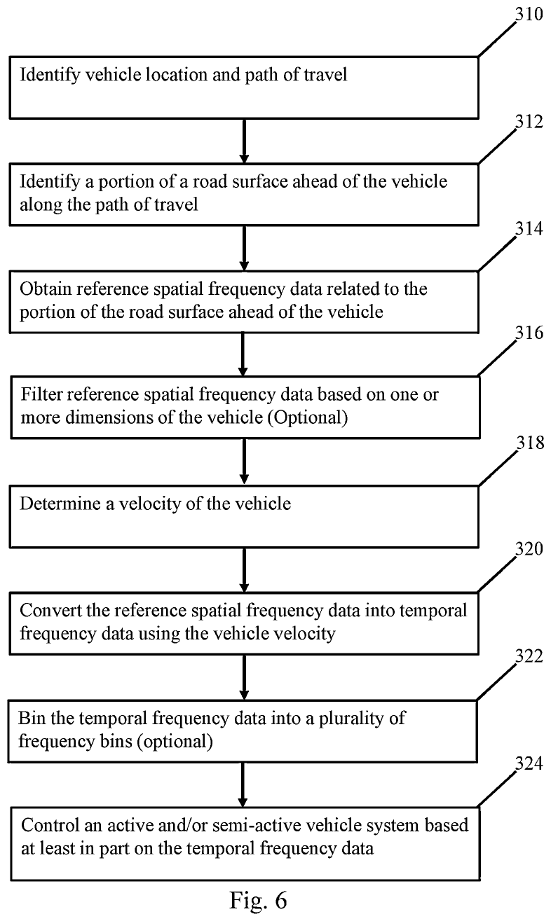

FIG. 6 shows one embodiment of a method that may be implemented by a system control module that may obtain temporal frequency data based on reference data related to a road surface. The system control module may then use that temporal frequency data to control operation of one or more systems of a vehicle. Depending on the particular embodiment, the system control module may be stored and the control logic may be executed at various locations of the vehicle. This may include a central processor of the vehicle that controls multiple subsystems of the vehicle and/or individual processors associated with the various systems that may execute the system control logic as the disclosure is not limited to where or how these control processes are implemented.

At 310 a vehicle location and path of travel along a road surface may be identified. For example, information from a localization system such as a Global Navigation Satellite System (GNSS), terrain based localization system, and/or any other appropriate localization system along with information from appropriate systems such as an autonomous vehicle control system, current and/or commanded steering angle, and/or inputs from other appropriate vehicle systems may be provided to a processor. The processor may identify the vehicle location and a likely path of travel of the vehicle across a portion of the road surface located ahead of the vehicle relative to the direction of travel. For example, a steering angle and current location and heading, mapped road lanes and direction of travel, commanded path by an autonomous vehicle control, or other appropriate method may be used to determine the expected path of travel. The processor may also identify a portion of the road surface that is ahead of the vehicle along the path of travel with a desired length at 312. The length of the portion of the road surface may either be predetermined and/or variable depending on the desired application as noted previously. In either case, a portion of the road corresponding to the desired length located on the path of travel of the vehicle may be selected. The processor may then obtain reference spatial frequency data related to the identified portion of the road surface at 314. Depending on the particular embodiment, the processor may obtain the desired reference spatial frequency data either by recalling it from memory, loading it into a buffer from data downloaded from a remote database and/or server, and/or any other appropriate method for obtaining the reference spatial frequency data from a roadmap including the selected portion of the road surface.

Due to different vehicles being constructed differently, and thus, reacting to inputs from a road surface differently from one another, it may be desirable to filter reference spatial frequency data based on one or more dimensions of a vehicle in some embodiments at 316. For instance, another aspect of the spatial frequency content shown in Error! Reference source not found.B is the fact that a road vehicle with multiple axles is affected by an effect called “wheel base filtering”. This effect is explained in a vehicle with four wheels, spaced apart by t_{w} in the transverse, or lateral, dimension and by w_{b} in the longitudinal direction (along the travel direction of the vehicle). Without wishing to be bound by theory, and under the assumption that the front and rear wheels are directly in line with each other, and that the vehicle is driving substantially in a straight line, any road input encountered by the front wheel on one side of the vehicle will also be encountered by the rear wheel on the same side, with a time delay that is inversely proportional to the vehicle velocity in the manner given below:

$${Δ}_{t} = \frac{{w}_{b}}{{v}_{x}}$$

where Δₜ is the time delay and vₓ is the velocity of the vehicle in line with the longitudinal axis of the vehicle.

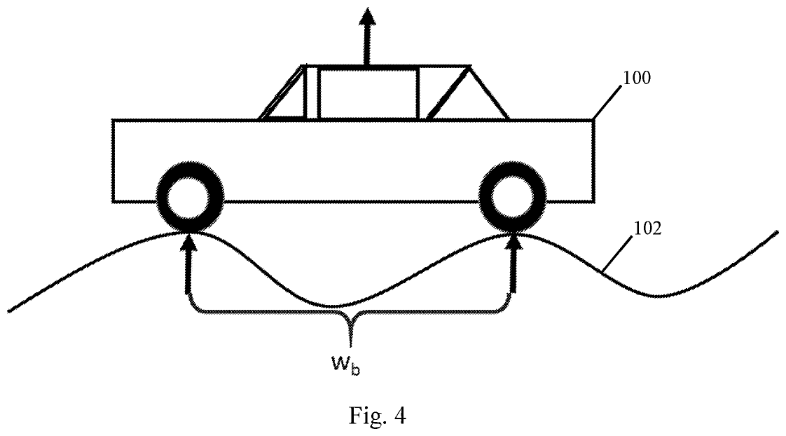

Assuming the vehicle to be a rigid body, the total input into the vehicle may be decomposed into the heave, pitch, and roll directions by summing the individual inputs at each wheel. For the heave direction, all four inputs may be summed; for roll, the two right side inputs may be added to the two left side inputs, and for the pitch direction, the two rear inputs may be added to the two front inputs, while accounting for the proper direction of the inputs. Since the input on each rear wheel is a delayed version of the input at each front wheel, there are certain spatial frequencies that cannot create heave, pitch, or roll inputs. For example, a road surface following a sine wave like profile with a wavelength corresponding to the wheelbase dimension w_{b} (i.e. spatial frequencies of 1/w_{b}) and odd multiples of the frequency (1×, 3×, 5×, . . . ) may not create any pitch input, since the front and rear wheels at that frequency are exposed to the same input at the same time. This is illustrated in FIG. 4 where the vehicle 100 is located on a road surface 102 that follows a curved profile with a wavelength equal to the wheelbase dimension. A similar discussion may be made for heave at spatial frequencies of even multiples of 1/w_{b} resulting in a physical “comb filter” of the road inputs based on the design of the vehicle.

In view of the above, in some embodiments, a comb filter may be applied to the reference spatial frequency data based on one or more physical dimensions of the vehicle at 316. An appropriate filter may be implemented by a processor using appropriate predetermined dimensions and/or frequencies based on the vehicle the method is being implemented on. For example, a manufacturer may preprogram the appropriate filter and/or a user may input the information using any appropriate input device as the disclosure is not limited to how a filter may be applied to the data. Regardless of how the filter is implemented, in some embodiments, the reference spatial frequency data may be filtered by the appropriate comb filter for one or more, and in some instances each, of heave, pitch, roll, and twist (e.g. unequal loading of the vehicle body including, for example, an increased force on two opposing corners and a decreased force on the other two opposing corners of a four wheeled vehicle relative to a nominal force distribution on the corners) of the vehicle before being transformed into temporal frequency data. This may provide a more accurate representation of the inputs to a vehicle that are to be expected when traversing the road surface, and can be used for control parameter tuning in real time while driving.

Turning again to FIG. 6, the method may include determining a velocity of the vehicle at 318. As noted previously, the velocity may correspond to either an instantaneous velocity of the vehicle and/or an average velocity of the vehicle over a predetermined time period. Additionally, the velocity may be determined using any appropriate sensor and/or input. For example, an input from a speedometer of a vehicle, a velocity meter, a shaft encoder, an appropriately configured GNSS receiver and/or any other appropriate component capable of sensing and/or outputting a velocity of the vehicle may be used. Once the velocity has been determined, the vehicle velocity may be used to convert the reference spatial frequency data into temporal frequency data at 320 using a method similar to that described above relative to FIG. 3D. Specifically, in some embodiments, at least the spatial frequency ranges of the reference spatial frequency data may be multiplied by the velocity of the vehicle to transform the data from the spatial frequency domain to the temporal frequency domain.

While in some embodiments, the temporal frequency data may be used without any additional processing, in some embodiments, it may be desirable to further refine how the data is processed for particular applications. Specifically, certain systems may change their operation based on inputs that occur in one or more specific frequency bands. For example, a first system may be controlled based on data associated with one or more first frequency bands while a second system may be controlled based on data associated with one or more second frequency bands which may either be the same or different from those associated with the first device. Accordingly, in some embodiments, the temporal frequency data may be separated into a plurality of separate temporal frequency bins. While it may be possible to perform this operation on a remote server, due to the frequencies being dependent on the velocity of a particular vehicle, it may be advantageous for the binning to be at least partially performed by one or more processors disposed on the vehicle. Regardless of where this binning is executed, the temporal frequency data may be separated into any number of bins depending on the particular systems that may be controlled. For example, in one embodiment shown in FIG. 3D, the frequency data may be sorted into contiguous or non-contiguous bins for use by a suspension system. As shown in the figure, the data may be sorted into a plurality of bins 250 that extend over different frequency ranges as elaborated on below. An output magnitude associated with the binned temporal frequency data may correspond to an average, summation, maximum selection, and/or any other appropriate process for determining an appropriate output magnitude to representative of the binned temporal frequency data.

In view of the bins illustrated in FIG. 3D, it should be understood that the frequency ranges associated with each bin do not need to be equal. Accordingly, any appropriate combinations of frequency ranges that are either equally spaced or unequally spaced may be used as the disclosure is not limited in this fashion. The frequency ranges also do not have to be contiguous, and in fact can overlap in part or not at all as desired. They also do not have to span the entire frequency range but rather can span any subset of the range.

Turning again to FIG. 6, at 324, one or more vehicle systems may be controlled based at least in part on the temporal frequency data, which as noted above may be binned in some embodiments. Depending on the specific application this may be implemented in a number of different ways. For example, when a magnitude associated with a particular frequency, or range of frequencies, is above or below one or more thresholds, one or more operating parameters of the system may toggle between different operating modes. This may include toggling between on/off states, different intensities of operation for a particular functionality, and/or any other appropriate method of operating the system. Correspondingly, in some embodiments, the temporal frequency data may be used to proportionally control one or more operating parameters of a system. For instance, an increased or decreased damping coefficient and/or active force control for a suspension system may be proportional to a magnitude of data associated with a particular frequency range. Other more specific examples are detailed further below.

In one embodiment, the above method may be used for controlling a motion sickness mitigation system. For example, in the event that a certain type of road frequency and direction (e.g. heave, pitch, and/or roll) is identified in an upcoming portion of a road that are particularly disturbing for motion sickness or other malady and/or fatiguing, preventive measures may be implemented. In one such embodiment, frequency ranges associated with motion sickness (e.g. below 0.5 Hz for heave and pitch motions, or between 3 Hz and 7 Hz if the occupant is reading, or other frequency ranges and directions as can for example be found in literature or selected based on a preference of the system designer) with magnitudes greater than a threshold magnitude may result in a suspension system more aggressively mitigating road force inputs to a vehicle body to avoid transferring this motion to a vehicle occupant. Similarly, other types of motion sickness mitigation systems may change their operation based on determining that an upcoming portion of a road may be likely to induce motion sickness in at least one occupant. This may include alerting the occupant through a user interface feedback or haptic input, increase a magnitude of cueing from haptic sources, and/or change environmental factors such as lighting or temperature settings, fans, or music volume or type. For example, remedies for mitigating motion sickness may include increasing cabin airflow, decreasing environmental temperature, increasing light intensity, and providing cues to the occupant by modifying the light conditions abruptly or by providing audible cues to name a few. Thus, the disclosure is not limited to these examples of motion sickness mitigation systems and controls as the concept may be applied to controlling any motion sickness mitigation method.

Another use of the disclosed methods and systems to mitigate motion sickness may include alerting the operator, or in the case of an autonomous or semi-autonomous vehicle, to alert the advanced driver-assistance system (ADAS system), to modify a velocity of the vehicle (i.e. to increase or decrease a velocity of the vehicle) to change a magnitude of the temporal frequency data in a predetermined frequency range relevant to motion sickness to be less than a desired threshold magnitude. For example, if a road contains large swells, traversing it at a lower velocity or higher velocity compared to the current velocity may be beneficial, depending on both the input frequency at a given driving velocity, and depending also at least in part on knowledge of the dynamics of the vehicle, for example based on a numerical model of such a vehicle. In some instances, increasing the velocity may make the input less perceptible or provocative, much the same way as increasing velocity on a washboard road on a motorcycle may make traversing it much more comfortable than at lower velocity.

Understanding the roughness of the road surface, especially in the frequency range relevant for the unsprung mass (wheel) resonance, may also help improve other functionalities of an autonomous and/or semi-autonomous system of a vehicle. For example, in a hard-braking event with Anti-Lock Braking (ABS) systems, it may be beneficial when driving on rough roads to reduce the amount of damping applied to the dampers to help ensure contact between the wheels and ground. Additionally, in some embodiments, when a semi-active suspension system is used, an algorithm may be used that applies high compression damping to the front and high rebound damping to the rear during a hard braking event, in order to facilitate faster load transfer to the road surface and thus decrease braking distances. When the road surface is rough, however, this may lead to the vehicle being overdamped and bouncing on the road, and thus to an increase in stopping distance. Thus, frequency ranges and output magnitudes associated with a rough road may be used to implement a first braking strategy and frequency ranges and output magnitudes associated with a smoother road may be used to implement a second braking strategy. Thus, knowing what road features are on a road surface prior to driving over the road surface may be used to adjust the operating parameters of the suspension system to improve performance of the braking system.

In another exemplary embodiment using the above disclosed methods, a semi-active suspension system with a two-stage valve may be used. This type of system allows for a variable damping rate of the dampers that may be quickly switched between two rates, one stiffer and one softer. For a typical road vehicle, a function of the dampers is to reduce vibrations in the low frequency range, for example below 1.5 Hz or below 2 Hz, that are the result of the system resonance of the sprung mass (the body of the vehicle including all parts that move with it) and the main suspension springs (the coil springs, air springs, torsion bars and rollbars along with parallel stiffness induced by bushings and other components). These vibrations may be excited by road input in a specific frequency range. It may therefore be desirable to increase the damping rate of at least one damper when the road input to a vehicle corresponds to either large magnitude and/or large numbers of road features that will apply road inputs to the vehicle in this frequency range, for example the range often called the primary ride frequency range, at the current driving speed. This may correspond to large output magnitudes for temporal frequency data in this frequency range. The increased damping rate may be provided by switching the semi-active suspension to its stiffer setting on at least one damper. It is also true, however, that for a typical vehicle higher frequency road inputs, for example in the range between 3 and 6 Hz, or the range between 2 and 8 Hz, or other ranges known to industry experts, may cause unwanted vibrations in the vehicle that are disturbing to the occupants. This disturbance is sometimes called chop, mid-frequency, or shake. In this frequency range, a desirable action may, for example, include reducing the damping value in at least one damper in order to reduce transmission of vibrations to the occupants. During a normal drive there may be competing interests or requirements which may favor reducing or increasing damping in the dampers, and potentially in the same damper, based on what road input is present. Schema can be devised by which the road features along an upcoming portion of a road surface may be known ahead of time, and a decision may be made on which setting to choose for the suspension damper based on a comparison between the magnitudes of the temporal frequency data in the primary ride frequency and in the chop frequency for the upcoming road segment. It may be preferable in some applications to switch to an appropriate setpoint in a timely manner due to the slow response of a vehicle and of some vehicle systems, and thus having a sufficient amount of advance warning, for example more than 1 second, may be desirable. This limits the ability of vision-based, lidar-based, or radar-based systems and other similar vehicle-borne sensing systems to be effective since they generally are unable to detect road features far enough ahead of the vehicle, especially at elevated driving speeds such as on highways and faster secondary roads. If for example the primary ride frequency content exceeds a first threshold, or exceeds a second threshold by a certain amount, while the chop frequency content does not exceed a third threshold, or exceeds a fourth threshold by a lower amount than the primary ride content exceeds the second threshold, then a decision may be made to increase damping in at least one damper in order to reduce vibration at the primary ride frequencies. An opposite decision might be made in the opposite case where the damping is decreased to reduce vibration in the chop frequency range. Other frequency bins may also be of interest for this decision, for example significant content in the frequencies around wheel hope, typically near 10-15 Hz, may favor increasing damping to reduce wheel bouncing and the associated shake that can often be perceived by vehicle occupants, while significant content above the wheel hop frequency range, for example in the range between 15 Hz and 30 Hz, might favor reducing damping. In each of these cases a decision may be made as to the which setting(s) is/are more desirable based on a comparison of the magnitudes of the temporal frequency data in each bin either to various thresholds, each other, and/or some other appropriate metric to determine a desired operating mode of the semi-active suspension system for the upcoming portion of the road surface.

The above discussion also holds true for more complicated suspension systems, such as for example, continuously variable semi-active damping systems, active suspension systems, active roll systems, and air spring systems, to name a few. A similar discussion can also be applied to other variable vehicle systems such as steering systems, brake systems and to other vehicle systems such as the audio system (which for example could raise the volume on roads that have content in frequency bands that cause the vehicle or its components to audibly vibrate and thus create higher background noise) and other interior systems. Additionally, while data related to an upcoming portion of a road surface may be used to control certain aspects of the operation of various systems, other inputs may also be taken into account when controlling the systems. For example, certain systems may receive control inputs from other systems as well. This may include inputs including, but not limited to, user profile settings for a particular device, operating mode selection, driving scenario, state of other vehicle systems, and/or any other appropriate input that may be used when determining the one or more operating parameters of a system as the disclosure is not limited to only using information related to the upcoming portion of a road surface for determining operation of one or more systems of a vehicle.

Thus, the current disclosure should not be limited to controlling the specific systems disclosed herein.

In some embodiments, systems in a road vehicle may have settings that are appropriate for certain types of events. For example, many semi-active suspensions attempt to recognize certain types of potholes that are short enough to allow the wheel to descend into the hole, but not give the entire vehicle time to fall down as well. In order to recognize this event, sensor signals may be analyzed to determine that a wheel accelerating downward because the reaction force of the ground has been reduced. In some embodiments after a certain time period, a determination may be made that the wheel is entering a type of pothole that should activate the algorithm in question. However, since a road profile may be unpredictable, this may not be the correct strategy, and it may lead to a reduction in comfort or vehicle damage if the shape of the pothole is different from what was anticipated.

In view of the above, in some embodiments, road preview may be used to predict a probability of the occurrence of certain types of events and corresponding control strategies may be implemented for the systems of a vehicle based at least partly on the determined probabilities associated with encountering a particular event such as a road feature on a road surface. Specifically, in some embodiments, possessing a priori knowledge of a certain type of event, such as a certain type of pothole, that the vehicle is about to traverse, permits appropriate mitigation algorithms to be engaged earlier (even ahead of the event) and with higher confidence (thus allowing control of the system to be more aggressive which may improve overall performance of the system).

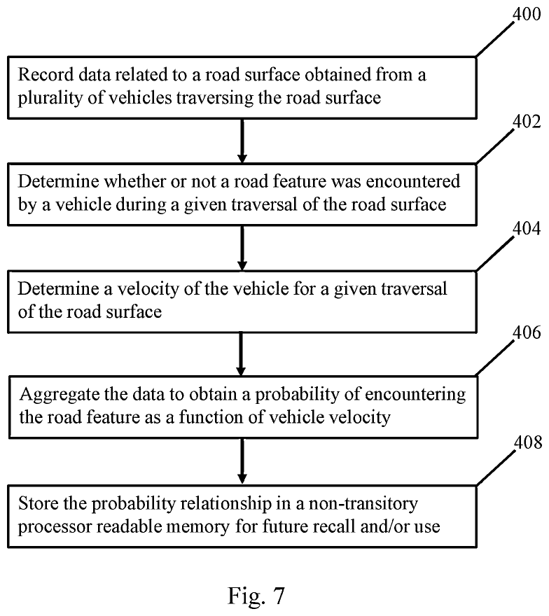

FIG. 7 depicts one embodiment of a method that may be implemented using a probability mapping module that may determine the probability of encountering one or more road features while traversing a portion of a road surface as a function of vehicle velocity. This information may then be included in a roadmap associating the probability information related to a road feature with a particular location on the road surface. For example, some vehicles may miss a small pothole due to their lateral position on the road, and some may identify it as a sharp pothole. At the same time, the same pothole may appear gentle at lower velocities, sharp at certain higher velocities, and may be unnoticeable again at certain even higher velocities (since the wheel may not have time to accelerate into the pothole). Depending on the embodiment, the probability mapping module may be stored and executed at various locations including being executed by a processor that is associated with a database and/or server that is remotely located from the vehicles. For example, a centralized database may be used to aggregate information for compiling roadmaps that may then be distributed to individual vehicles for implementing the methods described herein. However, embodiments in which the probability mapping module is executed by a processor on board an individual vehicle are also contemplated as the disclosure is not so limited.

In the depicted embodiment, data related to a road surface may be recorded for vehicles traveling across the road surface at various velocities at 400. The recorded data may correspond to any appropriate information related to the road surface that may be used to indicate whether or not a particular road feature was encountered by the vehicle when traversing the road surface at 402. For example, force inputs to a portion of the vehicle, acceleration inputs to a portion of vehicle, such as, height variations of the vehicle body and/or wheels relative to the underlying road surface, wheel speeds, and/or any other appropriate information may be sensed. The recorded data may also include corresponding location information sensed using any appropriate localization system as previously noted. This data may either be wirelessly transmitted from a vehicle to a remotely located device and/or the information may be stored locally on the vehicle and uploaded to a remotely located system at a later time. In either case, the sensed information may be analyzed to determine whether or not a road feature has been encountered by the vehicle using any method including, for example, threshold magnitudes, relative changes in sensed parameters, and/or any other appropriate method as the disclosure is not so limited. In addition to determining whether or not a road feature was encountered by vehicle, at 404, a velocity of the vehicle may be determined using any appropriate sensor and/or input from a system of the vehicle or external signals as previously discussed herein.

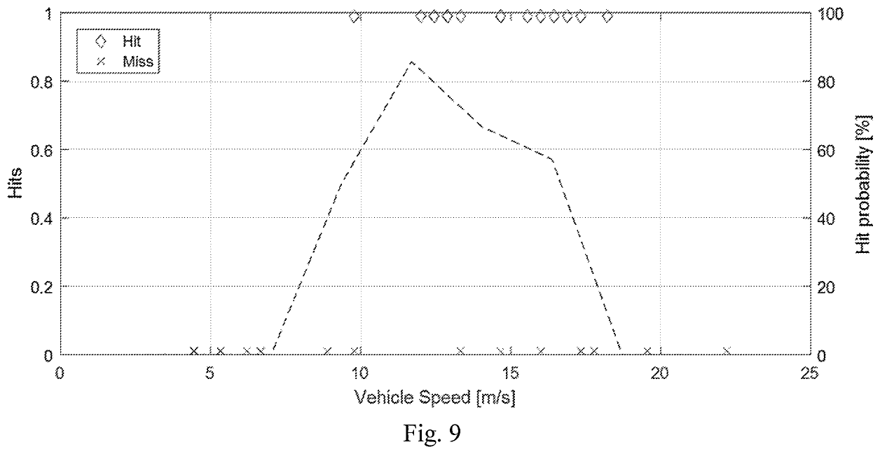

The resulting data from either multiple passes of a single vehicle and/or a plurality of different vehicles over the road surface may be aggregated to obtain a probability of encountering one or more road features on the road surface as a function of the vehicle velocity at 406. For example, in some embodiments, in order to characterize events based on crowd-sourcing, every drive or a statistically sufficient number of drives over a given road segment may be tracked to determine if an event has been detected or not as described above. In some embodiments, the number of “hits” and “misses” corresponding to whether or not a road feature was encountered or detected by the vehicle at the different vehicle velocities may be aggregated to determine a probability of encountering one or more road features on a particular portion of a road surface as a function of velocity. The resulting relationship of the probability of encountering the road feature versus vehicle velocity may be provided in the form of a lookup table, a fitted function, and/or any other appropriate method of providing a model of the probability as a function of vehicle velocity. Regardless of the specific form of the model, the model of the probability versus vehicle velocity may be stored in a non-transitory processor readable memory for feature recall and/or use at 408. One example of a probability determining process is shown in FIG. 9 where hits and misses for a particular road feature are plotted versus vehicle velocity. A resulting probability from the aggregated data at the different vehicle velocities is then shown by the plotted dashed line.

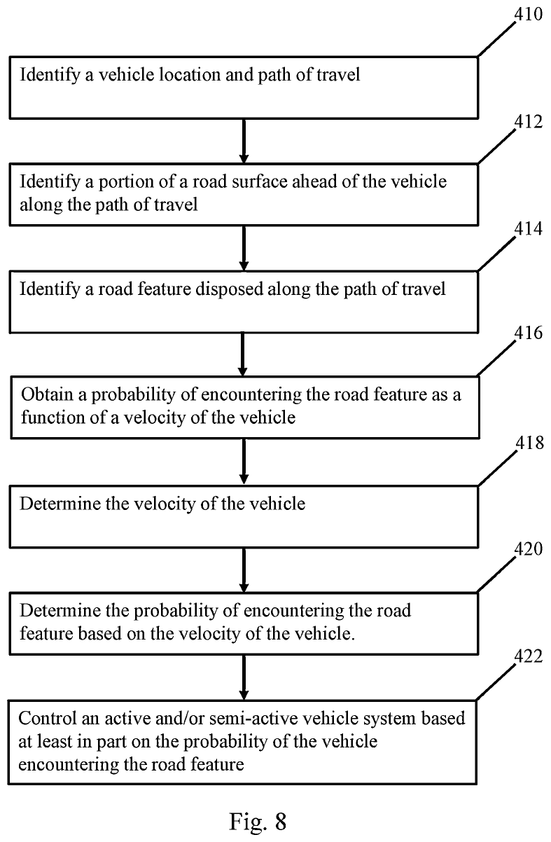

FIG. 8 depicts one embodiment of a probability control module that may be used to control operation of one or more systems of a vehicle based on a probability of encountering one or more road features located on a road surface. Depending on the particular embodiment, the probability control module may be stored and executed at various locations on board the vehicle. This may include a central processor of the vehicle that controls multiple subsystems of the vehicle and/or individual processors associated with the various systems that may be controlled as the disclosure is not limited to where or how these control processes are executed.

In the depicted embodiment, a vehicle location and path of travel of a vehicle on a road surface may be determined at 410 as previously discussed above. A portion of the road surface located ahead of the vehicle along the path of travel may then be determined at 412 as also discussed above. One or more road features included in the portion of the road surface along the path of travel of the vehicle may then be identified at 414. These road features may be included in a roadmap associated with the upcoming portion of the road surface. As noted previously, the roadmap may either be stored locally on the vehicle and/or may be uploaded into a buffer on the vehicle for usage. In either case, the roadmap may include information related to a probability of encountering the one or more road features along the path of travel of the vehicle as a function of a velocity of the vehicle. For example, a roadmap including the aggregated probability data described above relative to the method of FIG. 7 might be used. In any case, the probability of encountering the road feature as a function of the velocity of the vehicle may be obtained from the roadmap at 416. Correspondingly, a velocity of the vehicle may be determined at 418 using any appropriate sensor and/or input from another vehicle system as described previously.

After obtaining the vehicle velocity and the probability of encountering a road feature versus velocity, the probability of encountering the road feature based on the current, expected, or predicted velocity of the vehicle may be determined at 420. For instance the velocity may be used with a look up table, fitted function, or other model of the probability of encountering the road feature versus velocity. This determined probability may then be used to control one or more operating parameters of a vehicle system at 422. This may include changes in one or more operating parameters of the system based on one or more thresholds relative to the probability, proportional control of the parameters based on the probability, comparisons of the relative magnitudes of the probabilities of encountering different types of road features, combinations of the foregoing, and/or any other appropriate method of controlling the operating parameters of a system based on the probability. For example, turning again to exemplary FIG. 9, when a vehicle traverses a road, the probability control module may determine the probability of encountering and detecting a certain event. For example, in the chart, if the vehicle is travelling at 12 m/s, then the probability of detectably encountering the event is high and the prevention algorithm may be engaged with a high degree of certainty. If the vehicle on the other hand has slowed down to 6 m/s, then the probability is low and the correct choice may be to not engage the prevention algorithm.

In some embodiments, classifying a given pothole as having a “small” effect or a “large” effect may lead to a plot of occurrence showing a small pothole being more likely a pothole traversed at high velocities, and a large pothole being more likely at low velocities. Because of tire and vehicle dynamics, the same road feature may be perceived differently when traversed at different velocities. In some embodiments, when determining a road profile, a classification of both “small” and “large” potholes may be achieved by creating a map of occurrence vs velocity without having to actually collect the data on multiple occasions.

In some embodiments, it may be possible to update the selected operating parameters of a vehicle system based on the system performance after encountering a road feature. In such an embodiment, every time an event occurs the shape and/or type of the input and the resulting performance output may be recorded. For example, the vertical acceleration of the vehicle body may be recorded, along with the current tuning parameters of the mitigation algorithm. This information may then be used to progressively improve the tuning to optimize the desired performance parameters. For instance, a combination of average or root mean square, and peak of the vertical body acceleration immediately upon encountering the pothole, while traversing the pothole, and/or during a short period of time after traversing a pothole may be used as a performance metric for an aftershake control algorithm in a semi-active or active suspension system. Tuning parameters, pothole incidences, and the resulting performance metric for a number of pothole crossings may then be tracked, and the tuning parameters may be modified to identify system settings exhibiting improved performance. In some embodiments, this may allow for adaptive tuning as the vehicle changes, for example, taking into account age or different loading.

In another exemplary embodiment, a probability control module may be used to control the suspension system of a vehicle where there is a hill cresting event. In such an embodiment, the damping setpoint may be low (i.e. soft response) in the beginning of the hill in order to gently move the car up the hill, and then high (i.e. stiff rebound response) as soon as the vehicle is starting to reach the crest of the hill, in order to allow it to follow the road back down. Without a priori knowledge, the soft setting may be kept for longer in order to avoid poor comfort should the hill continue on, thus creating the need for a stronger response once it becomes clear that the road starts “falling away” from the vehicle at the crest of the hill.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Also, a processor may be associated with one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch screens, touch pads, and digitizing tablets. As another example, a processor may receive input information through speech recognition or in other audible format.

Such processors may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a processor readable storage medium (or multiple processor readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computing device or other processors, perform methods that implement the various embodiments discussed above. As is apparent from the foregoing examples, a processor readable storage medium may retain information for a sufficient time to provide processor-executable instructions in a non-transitory form. Such a processor readable storage medium or media can be transportable, such that the program or programs stored thereon can be loaded onto one or more different computing devices or other processors to implement various aspects of the present disclosure as discussed above. As used herein, the term “processor-readable storage medium” or “processor-readable memory” encompasses only a non-transitory processor-readable medium that can be considered to be a manufacture (i.e., article of manufacture) or a machine. Alternatively or additionally, the disclosure may be embodied as a processor readable medium other than a processor-readable storage medium, such as a propagating signal.

The terms “program” or “software” are used herein in a generic sense to refer to any type of computer code or set of processor-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Processor-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A method of controlling one or more systems, the method comprising:
identifying a portion of a road surface along a path of travel of a vehicle;
obtaining reference spatial frequency data related to the portion of the road surface along the path of travel of the vehicle;
determining a velocity of the vehicle;
transforming the reference spatial frequency data into temporal frequency data using the determined velocity of the vehicle; and
controlling the one or more systems based at least in part on the temporal frequency data.

2. The method of claim 1, further comprising binning the temporal frequency data into a plurality of frequency bins.

3. The method of claim 2, wherein controlling the one or more systems includes controlling the one or more systems based at least in part on an output magnitude of one or more frequency bins of the plurality of frequency bins.

4. The method of claim 2, wherein the one or more systems includes a first system and a second system, and wherein the first system is controlled based at least in part on a first frequency bin and the second system is controlled based at least in part on a second frequency bin that is different from the first frequency bin.

5. The method of claim 2, wherein controlling the one or more systems includes controlling the one or more systems based at least in part on an absolute or relative output magnitude of one or more of the plurality of frequency bins.

6. The method of claim 1, further comprising filtering the reference spatial frequency data based on one or more dimensions of the vehicle.

7. The method of claim 6, wherein the reference spatial frequency data is filtered using a comb filter.

8. The method of any one of claims 1-7, wherein the one or more systems include a semi-active suspension system and/or an active suspension system.

9. A method of controlling one or more systems, the method comprising:
identifying a road feature disposed along a path of travel of a vehicle;
obtaining a probability of encountering the road feature as a function of a velocity of the vehicle;
determining a velocity of the vehicle;
determining the probability of encountering the road feature based on the velocity of the vehicle; and
controlling one or more systems based at least in part on the determined probability of encountering the road feature.

10. The method of claim 9, wherein obtaining the probability of encountering the road feature as a function of the velocity of the vehicle includes obtaining a model of the probability of encountering the road feature as a function of the velocity.

11. The method of claim 10, wherein determining the probability of encountering the road feature includes determining the probability of encountering the road feature based on the velocity of the vehicle and the model.

12. The method of claim 10, wherein the model is a lookup table or fitted function.

13. The method of any one of claims 9-12, wherein the one or more systems include a semi-active suspension system and/or an active suspension system.

14. A vehicle comprising:
one or more systems;
a localization system configured to determine a location of the vehicle; and
a processor configured to:
identify a portion of a road surface along a path of travel of a vehicle based on an input from the localization system;
obtain reference spatial frequency data related to the portion of the road surface along the path of travel of the vehicle;
determine a velocity of the vehicle;
transform the reference spatial frequency data into temporal frequency data using the determined velocity of the vehicle; and
control the one or more systems based at least in part on the temporal frequency data.

15. The vehicle of claim 14, wherein the processor is configured to bin the temporal frequency data into a plurality of frequency bins.

16. The vehicle of claim 15, wherein the processor is configured to control the one or more systems based at least in part on an output magnitude of one or more frequency bins of the plurality of frequency bins.

17. The vehicle of claim 15, wherein the one or more systems includes a first system and a second system, and wherein the processor is configured to control the first system based at least in part on a first frequency bin and the second system based at least in part on a second frequency bin that is different from the first frequency bin.

18. The vehicle of claim 15, wherein the processor is configured to control the operating parameters of the one or more systems based at least in part on an absolute or relative output magnitude of one or more of the plurality of frequency bins.

19. The vehicle of claim 14, wherein the processor is configured to filter the reference spatial frequency data based on one or more dimensions of the vehicle.

20. The vehicle of claim 19, wherein the processor is configured to filter the reference spatial frequency data with a comb filter.

21. The vehicle of any one of claims 14-20, wherein the one or more systems include a semi-active suspension system and/or an active suspension system.

22. A vehicle comprising:
one or more systems;
a localization system configured to determine a location of the vehicle; and
a processor configured to:
identify a road feature disposed along a path of travel of the vehicle;
obtain a probability of encountering the road feature as a function of a velocity of the vehicle;
determine a velocity of the vehicle;
determine the probability of encountering the road feature based on the velocity of the vehicle; and
control the one or more systems based at least in part on the determined probability of encountering the road feature.

23. The vehicle of claim 22, wherein the processor is configured to obtain a model of the probability of encountering the road feature a function of the velocity.

24. The vehicle of claim 23, wherein the processor is configured to determine the probability of encountering the road feature based on the velocity of the vehicle and the model.

25. The vehicle of claim 23, wherein the model is a lookup table or fitted function.

26. The vehicle of any one of claims 22-25, wherein the one or more systems include a semi-active suspension system and/or an active suspension system.

27. A method of generating a road map for use in controlling a vehicle system, the method comprising:
determining if each vehicle of a plurality of vehicles that traverse a road surface encounter a road feature;
determining a velocity of each vehicle;
determining a probability of encountering the road feature as a function of the velocity; and
storing a model related to the probability of encountering the road feature in a non-transitory processor readable memory for future recall and/or use.

28. The method of claim 27, further comprising including the model in a roadmap including the road surface.

29. The method of claim 27, further comprising obtaining information related to one or more inputs from the road surface to the plurality of vehicles to determine if each of the vehicles encountered the road feature.
